(19) United States
(12) Patent Application Publication
(10) Pub. No.: US 2009/0003185 A1
(43) Pub. Date: Jan. 1, 2009

(54) OPTICAL DISC APPARATUS AND OPTICAL DISC APPARATUS CONTROL METHOD

(75) Inventors: Hirokazu Shou, Musashimurayama-shi (JP); Kazumi Sugiyama, Kawasaki-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 12/147,965

(22) Filed: Jun. 27, 2008

(30) Foreign Application Priority Data
Jun. 29, 2007 (JP) 2007-173050

(51) Int. Cl. G11B 7/00

(52) U.S. Cl. 369/121

(57) ABSTRACT

According to one embodiment, an optical disc apparatus includes a laser diode configured to irradiate a laser beam onto an optical disc, a laser drive circuit configured to supply the laser diode with a laser drive current superposed with a high frequency electric current according to defined conditions of the high frequency electric current in order to turn the laser beam output from the laser diode to a multimode laser beam, a detecting section configured to detect a frequency condition of the high frequency electric current to reduce a quantity of interlayer crosstalk, and a setting section configured to set the detected condition in the laser drive circuit.

### CROSS REFERENCE TO RELATED APPLICATION

This application is based upon and claims the benefit of priority from Japanese Patent Application No. 2007-173050, filed Jun. 29, 2007, the entire contents of which are incorporated herein by reference.

### BACKGROUND

1. Field

One embodiment of the present invention relates to an optical disc apparatus for suppressing interlayer crosstalk noise and an optical disc control method.

2. Description of the Related Art

When reproducing a signal from a target layer of an optical disc having a plurality of layers, degradation of the S/N ratio of the reproduced signal occurs as light reflected from any of the other layers is added as interlayer crosstalk noise to light reflected from the target layer to consequently degrade the read performance of the optical disc apparatus.

Jpn. Pat. Appln. Laid-Open Publication No. 2002-319177 discloses a technique of canceling the interlayer crosstalk by detecting the interlayer crosstalk signal in the periphery of a converged beam of light at the time of converging light reflected from a target recording layer and detecting the reproduced signal and performing a differential operation with the reproduced signal.

With the above-described technique, it is necessary to provide an optical device having a light receiving section for detecting the interlayer crosstalk and arranged around a special light receiving section for detecting the reproduced signal to consequently raise the overall manufacturing cost.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary schematic block diagram of an embodiment of optical disc apparatus according to the present invention, showing the configuration thereof;

FIG. 2A and FIG. 2B are exemplary schematic illustrations of a laser beam turned to a multimode laser beam;

FIG. 3 is an exemplary schematic block diagram of an arrangement for searching for the conditions for suppressing the interlayer crosstalk noise and setting the conditions in a laser drive circuit;

FIG. 4 is an exemplary flowchart of the sequence of the process for searching for the conditions for suppressing the interlayer crosstalk noise;

FIG. 5 is an exemplary schematic illustration of an exemplar optical disc divided into a plurality of regions; and

FIG. 6 is an exemplary flowchart of the sequence of the process for defining the conditions for suppressing the interlayer crosstalk noise in an optical disc replay operation.

### DETAILED DESCRIPTION

Various embodiments according to the invention will be described hereinafter with reference to the accompanying drawings. In general, according to one embodiment of the invention, an optical disc apparatus includes a laser diode configured to irradiate a laser beam onto an optical disc, a laser drive circuit configured to supply the laser diode with a laser drive current superposed with a high frequency electric current according to defined conditions of the high frequency electric current in order to turn the laser beam output from the laser diode to a multimode laser beam, a detecting section configured to detect a frequency condition of the high frequency electric current to reduce a quantity of interlayer crosstalk, and a setting section configured to set the detected condition in the laser drive circuit.

Now, a preferred embodiment of the present invention will be described below in greater detail by referring to the accompanying drawings.

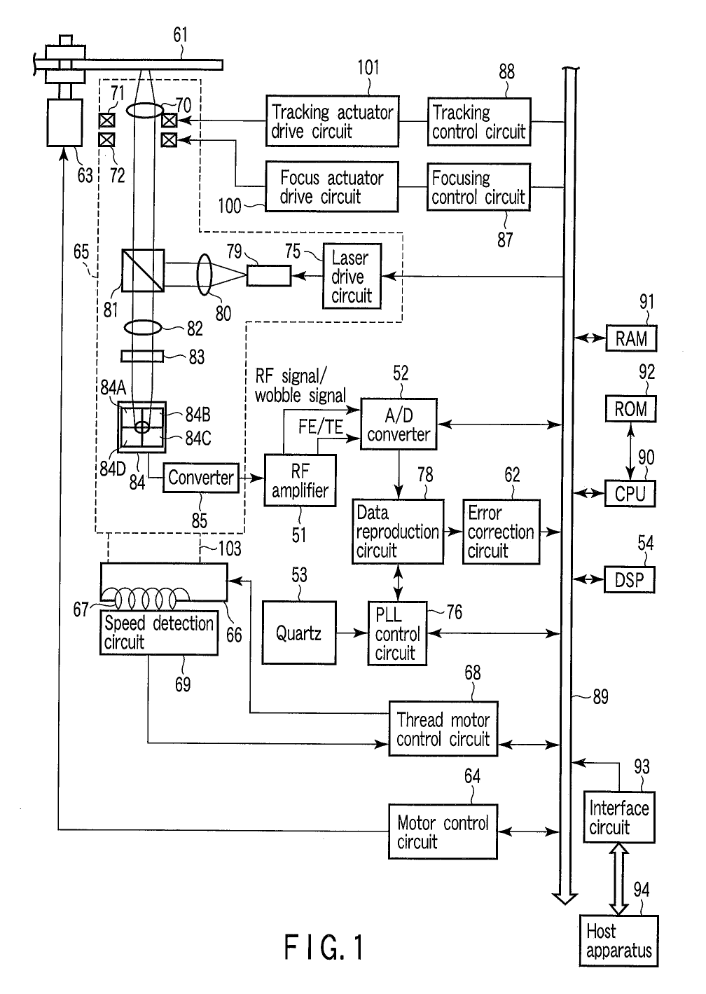

FIG. 1 is a schematic block diagram of an embodiment of optical disc apparatus according to the present invention, showing the configuration thereof.

The optical disc 61 to be set in position in the optical disc apparatus 11 may be an optical disc on which the user data can be recorded or a read-only optical disc. This embodiment will be described in terms of an optical disc having a multilayer structure. While a DVD-R may be popular as an optical disc having a multilayer structure on the information recording surface thereof, the present invention is by no means limited thereto and any optical disc having a multilayer structure may be used for the purpose of the present invention.

The information recording surface of the optical disc 61 has land tracks and groove tracks formed spirally thereon. The optical disc 61 is driven to rotate by means of a spindle motor 63.

Information is recorded on and reproduced from the optical disc 61 by means of a pickup head 65 (the part surrounded by broken lines at the left side of FIG. 1). The pickup head 65 is linked to a thread motor 66 by way of a link section 103 including gears and the thread motor 66 is controlled by a thread motor control circuit 68.

Speed detection circuit 69 shown under the thread motor 66 in FIG. 1 is for detecting the moving speed of the optical pickup. It is connected to the above-described thread motor control circuit 68. The speed signal representing the moving speed of the pickup head 65 as detected by the speed detection circuit 69 is sent to the thread motor control circuit 68. A permanent magnet is arranged at the anchoring section of the thread motor 66 and the pickup head 65 is drive to move in a radial direction of the optical disc 61 as drive coil 67 is magnetically excited by the thread motor control circuit 68.

An objective lens 70 is arranged in the pickup head 65 and supported typically by means of a wire or a leaf spring (not shown). The objective lens 70 can be driven to move in the tracking direction (orthogonal to the optical axis of the lens) by a tracking drive coil 71. The objective lens 70 can be driven to move in the tracking direction (a direction orthogonal to the optical axis of the lens) and also in the focusing direction (the direction of the optical axis of the lens) by a focusing drive coil 72.

When information is recorded on the optical disc 61, modulation circuit 73 receives an information signal to be recorded from a host apparatus 94 by way of an interface circuit 93 and a bus 89 and modulates the signal by means of the method of modulation defined in the standard for the optical disc 61 (e.g., 8-16 modulation). When information is recorded (and marks are formed) on the optical disc 61, a laser drive circuit 75 supplies a write signal to semiconductor laser diode (laser oscillator) 79 according to the modulation data supplied from the modulation circuit 73. When information is reproduced from the optical disc 61, the laser drive circuit 75 supplies a read signal that is smaller than a write signal to the semiconductor laser diode 79.

The semiconductor laser diode 79 generates a laser beam according to the signal supplied from the laser drive circuit 75. The laser beam emitted from the semiconductor laser diode 79 is irradiated onto the optical disc 61 via a collimator lens 80, a half prism 81 and the objective lens 70. Light reflected from the optical disc 61 is lead to a photodetector 84 via the objective lens 70, the half prism 81, a condenser lens 82 and a cylindrical lens 83.

The semiconductor laser diode 79 in fact includes three semiconductor laser diodes that emit laser beams respectively for a CD (infrared: wavelength of 780 nm), for a DVD (red: wavelength of 650 nm) and for an HD DVD (blue purple: wavelength of 405 nm). These semiconductor laser diodes may be contained in the same CAN package or independently contained in three respective CAN packages and arranged individually on the base of the pickup head 65. The configuration and the arrangement of the optical system may vary depending to the configuration of the semiconductor laser.

Of the components of the optical system, the objective lens is designed to properly focus the laser beam for an HD DVD on the disc. The optical system includes aberration correcting elements (such as a diffraction element, a phase correction element, etc.) for suppressing aberrations that arise when using a laser beam for a DVD and a laser beam for a CD and numerical aperture limiting elements (such as a liquid crystal shutter, a diffraction element, etc.) for limiting the numerical aperture of the objective lens when using a laser beam for a CD.

The photodetector 84 includes photo detection cells 84A through 84D formed by quartering a cell. Each of the photo detection cells 84A through 84D outputs a signal representing an electric current value that corresponds to the intensity of light it receives. The output signals of the photo detection cells 84A through 84D of the photodetector 84 are input to an RF amplifier 51 by way of respective current/voltage converter 85.

The RF amplifier 51 amplifies the output signals of the photo detection cells 84A through 84D and generates a focus error signal FE, a tracking error signal TE, an RF signal and a wobble signal, which signals are converted into digital values by means of an A/D converter 52.

The focus error signal FE is a signal corresponding to (output of photo detection cell 84A+output of photo detection cell 84C)−(output of photo detection cell 84B+output of photo detection cell 84D). The focus error signal FE is supplied to a focusing control circuit 87. The focusing control circuit 87 supplies a drive signal that corresponds to the focus error signal FE to focus actuator drive circuit 100 so that the laser beam is so controlled as to be constantly in just focus on the recording surface of the optical disc 61.

The tracking error signal TE is a signal corresponding to (output of photo detection cell 84A+output of photo detection cell 84D)−(output of photo detection cell 84B+output of photo detection cell 84C). The tracking error signal TE is supplied to a tracking control circuit 88. The tracking control circuit 88 generates a tracking drive signal that corresponds to the tracking error signal TE. The tracking drive signal output from the tracking control circuit 88 is supplied to a tracking actuator drive circuit 101. The tracking actuator drive circuit 101 drives the tracking drive coil 71 in a direction orthogonal relative to the optical axis of the objective lens 70 according to the tracking drive signal so that the laser beam is so controlled as to be irradiated onto a predetermined spot on the recording surface of the optical disc 61. The tracking error signal TE is also supplied to the thread motor control circuit 68.

The RF signal is a signal corresponding to (output of photo detection cell 84A+output of photo detection cell 84B+output of photo detection cell 84C+output of photo detection cell 84C). PLL (phase locked loop) control circuit 76 extracts the reproduction clock signal that is supplied from a crystal oscillator 53 out of the RF signal. A data reproduction circuit 78 reproduces the RF signal according to the reproduction clock signal from the PLL control circuit 76 and generates a binarized signal.

The binarized signal is supplied to an error correction circuit 62. The error correction circuit 62 converts the signal into data of the format before the recording by executing an error correction process.

DSP 54 extracts the wobble component contained in the wobble signal by causing it to pass the band-pass filter circuit of a range of ±1 [Hz] with a center frequency of 22.05 [Hz] that is arranged in it and executes an FM demodulation process on the wobble component. Then, it detects the absolute address of the beam spot on the optical disc 61 from the outcome of the demodulation process and sends it out to CPU 90 as an address information signal.

The thread motor control circuit 68 controls the thread motor 66 so as to move the main body of the pickup head 65 in order to place the objective lens 70 at or near the center position in the pickup head 65.

The A/D converter 52, the data reproduction circuit 78, an error correction circuit 62, the PLL control circuit 76, the CPU 90, the DSP 54, the thread motor control circuit 68, the motor control circuit 64, the focusing control circuit 87 and the tracking control circuit 88 can be arranged in a single LSI chip. The CPU 90 comprehensively controls the optical disc recording/reproduction apparatus according to the operation command supplied to it from the host apparatus 94 via the interface circuit 93. Additionally, the CPU 90 uses a RAM 91 as a work area and performs predetermined control operations according to a program including the processes relating to this embodiment that is recorded in a ROM 92.

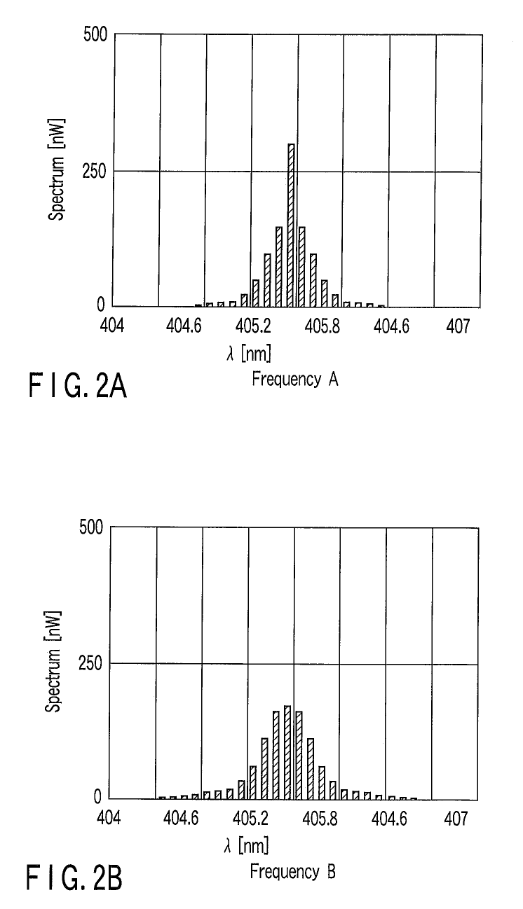

The above-described optical disc apparatus turns the laser beam output from the semiconductor laser diode 79 into a multimode laser beam as shown in FIGS. 2A and 2B by superposing a high frequency electric current to the laser beam in order to suppress interlayer crosstalk noise.

Since optimum conditions for suppressing interlayer crosstalk noise vary from optical disc to optical disc, this apparatus is adapted to search for optimum conditions for the optical disc loaded in the apparatus and controls the operation of driving the optical disc according to the conditions that are found by the search.

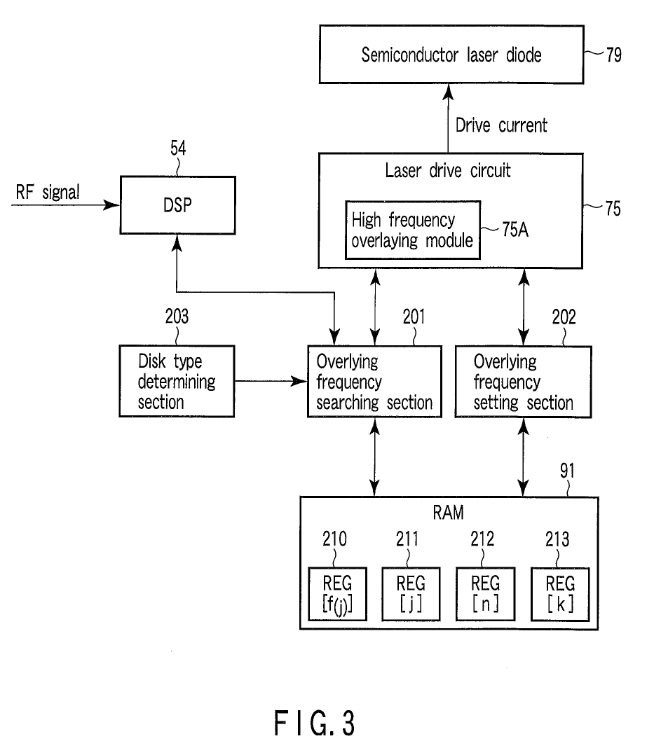

FIG. 3 is a schematic block diagram of an arrangement for searching for an optimum frequency condition of the high frequency electric current in order to suppress interlayer crosstalk noise and controlling the operation of driving the optical disc according to the condition found by the search.

Overlying frequency searching section 201 searches for the frequency of the high frequency electric current to be laid over the laser drive electric current in order to suppress interlayer crosstalk noise. The overlying frequency searching section 201 stores the frequency it found by the search in the register 210 in the RAM 91.

A superposing frequency setting section 202 sets the frequency condition of the high frequency electric current that is stored in the register 210 in a high frequency superposing module 75A of the laser drive circuit 75 at the time of replaying the optical disc.

A disc type determining section 203 determines the type of the optical disc loaded in the apparatus. The disc type determining section 203 then notifies the type of the optical disc to the superposing frequency searching section 201.

Note that the superposing frequency searching section 201, the superposing frequency setting section 202 and the disc type determining section 203 are realized as a program is executed for them by the CPU 90.

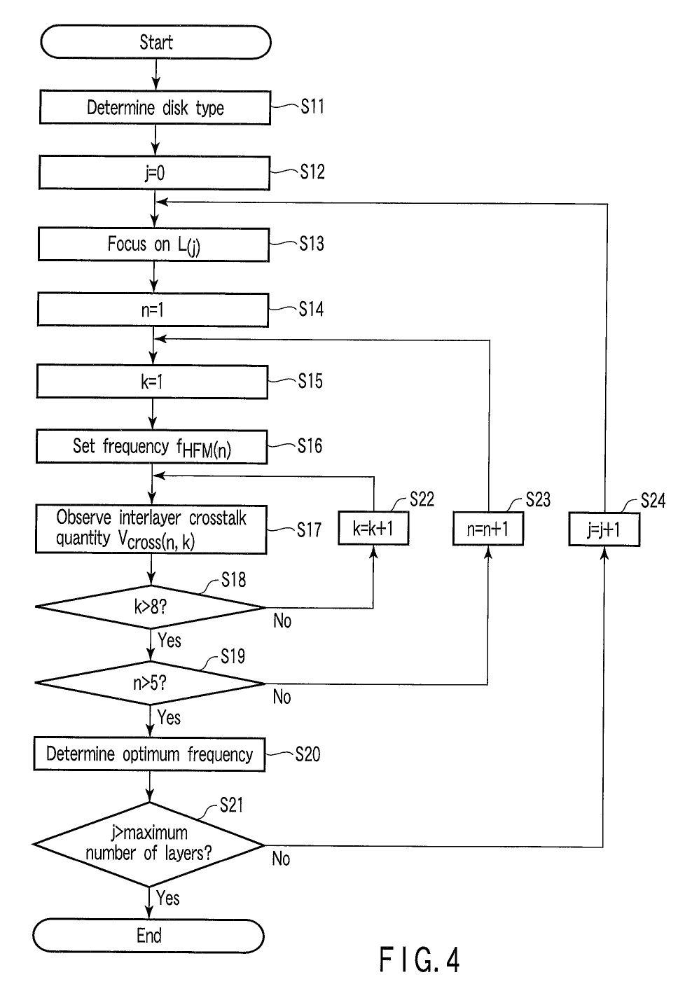

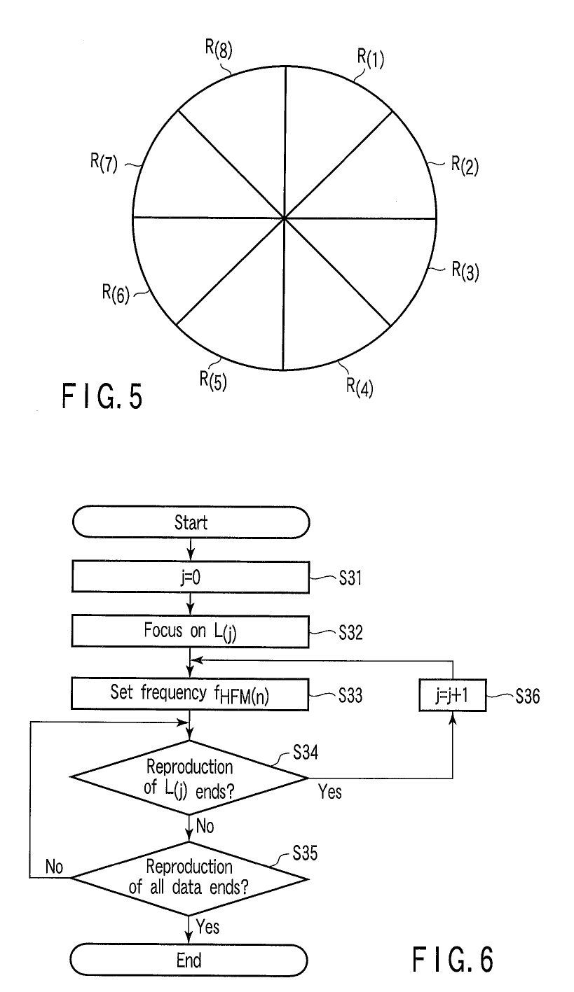

Now, the sequence of the process of searching for the frequency condition of the high frequency electric current in order to suppress interlayer crosstalk noise will be described below by referring to the flowchart of FIG. 4.

In this embodiment, the frequency of the high frequency electric current to be superposed the laser drive current that is supplied to the semiconductor laser diode 79 from the laser drive circuit 75 is made to change in order to search for an optimum frequency condition of the high frequency electric current for suppressing interlayer crosstalk noise. Note that five frequencies Of f_{HFM(1)}=300 MHz, f_{HFM(2)}=350 MHz, f_{HFM(3)}=400 MHz, f_{HFM(4)}=450 MHz and f_{HFM(5)}=500 MHz are selected for the high frequency electric current to be superposing the laser drive current.

Then, the envelope of the RF signal that corresponds to the quantity of interlayer crosstalk is measured for each of the frequencies.

Since the envelop of the reproduced signal changes due to influence of surface shake and/or eccentricity of the optical disc, a single turn of the optical disc is divided into a plurality of regions and the envelop of the reproduced signal is measured in order to separate the frequency component due to interlayer crosstalk and the frequency component due to surface shake and/or eccentricity of the optical disc. In this embodiment, the optical disc is circumferentially divided into eight regions R₍₁₎ through R₍₈₎ as shown in FIG. 5.

Firstly, as an optical disc is loaded in the apparatus, the disc type determining section 203 executes the disc determining process of determining the type of the inserted disc (S11). As the disc determining process is completed, it becomes clear if the inserted disc is a multilayer disc or a single layer disc.

The superposing frequency searching section 201 turns the value of j representing the reproduction layer or the recording layer and stored in the register 211 to 0 (Step S12). When the optical disc is an HD DVD, j can take a value that is equal to 0, 1 or 2. When the optical disc is a DVD or a Blue-ray disc, j can take a value that is equal to 0, or 1.

The superposing frequency searching section 201 controls the focusing control circuit 87 so as to focus on the reproduction layer or the recording layer Lj (Step S13). The superposing frequency searching section 201 turns the value of n representing the frequency of the high frequency electric current that is to be superposed the optical disc and stored in a register 212 to 1 (Step S14). The superposing frequency searching section 201 turns the value of k representing the peripheral region of the optical disc and stored in a register 213 to 1 (Step S15).

Then, the superposing frequency searching section 201 directs the high frequency superposing module in the laser drive circuit 75 to laying an electric current of a frequency of f_{HFM(n)} superposing the laser drive current (Step S16).

The superposing frequency searching section 201 has the DSP 54 measure the envelope of the RF signal as the interlayer crosstalk quantity V_{cross(n,k)} in the region Rk of the optical disc (Step S17). When the measurement of the interlayer crosstalk quantity V_{cross(n,k)} is over, the superposing frequency searching section 201 determines if the value of k is greater than 8 or not in order to determine if the measurement of the interlayer crosstalk quantity V_{cross(n,k)} is over in all the regions of the optical disc for the frequency f_{HFM(n)} (Step S18).

When it is determined that the value of k is not greater than 8 (Step S18, No), the superposing frequency searching section 201 increments the value of k stored in the register 213 by 1 in order to measure the interlayer crosstalk quantity V_{cross(n,k)} of the next region (Step S22). Then, it measures the interlayer crosstalk quantity V_{cross(n,k)}.

When, on the other hand, it is determined that the value of k is greater than 8 (Step S18, Yes), the superposing frequency searching section 201 determines if the value of n stored in the register 212 is grater than 5 or not in order to determine if the measurement of the interlayer crosstalk quantity V_{cross(n,k)} is over for all the frequencies of the optical disc (Step S19).

When it is determined that the value of n is not greater than 5 (Step S19, No), the superposing frequency searching section 201 increments the value of n stored in the register 212 by 1 in order to measure the interlayer crosstalk quantity V_{cross(n,k)} in all the regions R₍ₖ₎ for the next frequency f_{HFM(n)} (Step S23). Then, the superposing frequency searching section 201 makes the value of k representing the region R₍ₖ₎ of the optical disc stored in the register 213 equal to 1 (Step S15). Thereafter, the superposing frequency searching section 201 changes the frequency to be superposed on the laser drive current (Step S16) and measures the interlayer crosstalk quantity V_{cross(n,k)} (Step S17).

When, on the other hand, it is determined in Step S19 that the value of n is greater than 5 (Step S19, Yes), the superposing frequency searching section 201 determines the optimum frequency for suppressing the interlayer crosstalk quantity V_{cross(n,k)} of the recording layer Lⱼ (Step S20). The operation of determining the frequency will be described below. The superposing frequency searching section 201 calculates the interlayer crosstalk quantity V_{cross(n,k)} of each region typically by means of “(maximum value−minimum value)/maximum value”. Then, the average value of the interlayer crosstalk quantities V_{cross(n,k)} of each region is selected as the interlayer crosstalk quantity V_{cross(n,k)} at the frequency f_{HFM(n)}. Then, the superposing frequency searching section 201 determines the frequency that minimizes the interlayer crosstalk quantity at each frequency f_{HFM(n)} as the optimum frequency. The superposing frequency searching section 201 stores the optimum frequency it determines as f₍ⱼ₎ in the RAM 91.

Subsequently, the superposing frequency searching section 201 determines if the value of j stored in the register 211 is greater than the maximum number of layers or not (Step S21). When it is determined that the value of j is not greater than the maximum number of layers (Step S21, No), the superposing frequency searching section 201 increments the value of j by +1 (Step S24). Then, the superposing frequency searching section 201 controls the focusing control circuit 87 to make a layer jump to the recording layer L₍ⱼ₎ (Step S13) and repeats the steps from Step S14 to determine an optimum frequency (Step S20).

When, on the other hand, it is determined in Step S21 that the value of j is greater than the maximum member of layers (Step S21, Yes), the CPU 90 ends the operation of searching for a frequency.

With the above-described process, it is possible to find out an optimum frequency for each reproduction layer or recording layer.

The superposing frequency setting section 202 controls the determined superposing frequency in a manner as described below.

The superposing frequency setting section 202 makes the value of j stored in the register 211 and representing the focused on layer equal to 0 (Step S31). The superposing frequency setting section 202 makes the laser beam irradiated from the pickup head 65 focused on the reproduction layer or the recording layer L₍ⱼ₎ (Step S32).

The superposing frequency setting section 202 directs the high frequency superposing module in the laser driver circuit 75 to superpose the frequency f₍ⱼ₎ on the drive current (Step S33).

Then, throughout the operation of reproduction, the superposing frequency setting section 202 determines if the operation of reproduction from the reproduction layer or the recording layer L₍ⱼ₎ ends or not (Step S34). When it is determined that the operation of reproduction from the reproduction layer or the recording layer L₍ⱼ₎ ends, the value of j stored in the register 211 is incremented by 1. Then, the superposing frequency setting section 202 makes the laser beam irradiated from the pickup head 65 focused on the reproduction layer or the recording layer L₍ⱼ₎ (Step S32). The superposing frequency setting section 202 directs the high frequency superposing module in the laser drive circuit 75 to superpose the frequency f₍ⱼ₎ on the laser drive current (Step S33).

When, on the other hand, it is determined in Step S34 that the operation of reproduction from the reproduction layer or the recording layer L₍ⱼ₎ does no end (Step S34, No), the superposing frequency setting section 202 determines if the reproduction of all the data ends or not (Step S35). When it is determined that the reproduction of all the data ends (Step S35, Yes), the superposing frequency setting section 202 ends the process.

As a result of the above-described process, the quantity of interlayer crosstalk noise and hence the reproduction error ratio can be reduced by setting an optimum superposing frequency for each of layers. Additionally, the quantity of interlayer crosstalk noise that leaks into the focus error signal and the tracking error signal can be reduced to improve the stability of the focus servo and the tracking servo and the vibration noise of the actuator that is generated by disturbances of the servos is alleviated.

Note that the amplitude or both the amplitude and the frequency of the high frequency superposing electric current may be controlled to change the multimode conditions.

“The reproduction error ratio” or the quantity of jitter may be measured at the time when observing “the quantity of interlayer crosstalk (the envelop of the RF signal)” under various high frequency superposing conditions to search for and control the conditions that minimize these values obtained as a result of the observations. Note, however, that the observation of the envelop of the RF signal provides an advantage that it can be observed in a state where no PLL operation is taking place.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An optical disc apparatus comprising:
a laser diode configured to irradiate a laser beam onto an optical disc;
a laser drive circuit configured to supply the laser diode with a laser drive current superposed with a high frequency electric current according to defined conditions of the high frequency electric current in order to turn the laser beam output from the laser diode to a multimode laser beam;
a detecting section configured to detect a frequency condition of the high frequency electric current to reduce a quantity of interlayer crosstalk; and
a setting section configured to set the detected condition in the laser drive circuit.

2. The apparatus according to claim 1, wherein
the detecting section includes:
an measuring section arranged to measure quantities corresponding to a plurality of quantities of interlayer crosstalk, using the frequency or the amplitude of the high frequency electric current as parameter; and
an optimum setting computing section configured to determine an optimum frequency or amplitude of the high frequency electric current superposed the laser drive current from the quantities corresponding to a plurality of quantities of interlayer crosstalk for the parameter as measured by the measuring section.

3. The apparatus according to claim 2, wherein
the measuring section circumferentially divides the optical disc into a plurality of regions and measures the quantity corresponding to a plurality of quantities of interlayer crosstalk, using the frequency or the amplitude of the high frequency electric current as parameter, for each of the regions.

4. The apparatus according to claim 2, wherein
the quantities corresponding to a plurality of quantities of interlayer crosstalk is a quantities of an envelop of the reproduced signal of the optical disc.

5. The apparatus according to claim 2, wherein
the quantities corresponding to a plurality of quantities of interlayer crosstalk is a reproduction error ratio.

6. The apparatus according to claim 1, wherein
the search for the condition of the high frequency electric current to reduce the quantity of interlayer crosstalk by the detecting section is conducted at one more one layers of the optical disc.

7. A method of controlling an optical disc apparatus having a laser diode configured to irradiate a laser beam onto an optical disc and a laser drive circuit for supplying the laser diode with a laser drive current superposed with a high frequency electric current according to defined conditions of the high frequency electric current in order to turn the laser beam output from the laser diode to a multimode laser beam, the method comprising:
detecting a frequency condition of the high frequency electric current to reduce a quantity of interlayer crosstalk; and
setting the detected condition in the laser drive circuit.

8. The method according to claim 7, wherein
the detecting a condition include:
measuring a quantities corresponding to a plurality of quantities of interlayer crosstalk, using a frequency or an amplitude of the high frequency electric current as parameter; and
determining an optimum frequency or an amplitude of the high frequency electric current from the measured quantity corresponding to a plurality of quantities of interlayer crosstalk for the parameter.

9. The method according to claim 8, wherein
the measuring is include circumferentially dividing the optical disc into a plurality of regions, and measuring the quantities corresponding to a plurality of quantities of interlayer crosstalk, using the frequency or the amplitude of the high frequency electric current as parameter, for each of the regions.

10. The method according to claim 8, wherein
the quantities corresponding to a plurality of quantities of interlayer crosstalk is a quantities of an envelop of the reproduced signal of the optical disc.

11. The method according to claim 8, wherein
the quantities corresponding to a plurality of quantities of interlayer crosstalk is a reproduction error ratio.

12. The method according to claim 7, wherein
the detecting for the condition of the high frequency electric current to reduce the quantities of interlayer crosstalk is conducted at one more one layers of the optical disc.
